(19) United States
(12) Patent Application Publication
(10) Pub. No.: US 2007/0041529 A1
(43) Pub. Date: Feb. 22, 2007

(54) Synchronous parallel acoustic transmission in transtelephonic medical monitors

(76) Inventors: Harry Louis Platt, Eastgarden (AU); Allan Michael Shell, Eastgarden (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/442,012

(22) Filed: May 26, 2006

Related U.S. Application Data
(63) Continuation of application No. 11/139,242, filed on May 27, 2005, now abandoned.
Application No. 11/139,242 is a continuation of application No. 10/416,750, filed on Mar. 29, 2004, now abandoned.

(30) Foreign Application Priority Data
Nov. 10, 2000 (AU) PR 1386

(51) Int. Cl. H04M 11/00

(52) U.S. Cl. 379/93.01

(57) ABSTRACT

A method synchronous parallel transmission of digital signals over a telephone line is disclosed. The method includes the steps of generating a synchronization signal having at least two frequencies (6 and 7), simultaneously generating data signals having at least two separate frequencies from the digital signals, converting the synchronization signal and the data signals into audio signals having frequencies corresponding to frequencies of the synchronization signal and the data signals to be transmitted over the telephone line and transmitting at least three frequencies of the audio signals simultaneously over the telephone line.

The present invention relates to the field of monitoring of biological signals and transmission of the recorded data to a receiving station over the telephone network. In particular the invention relates to implementation of several logic levels represented by specific frequencies in telephone line audible range which allows for parallel transmission of digitized biological data in digital form. Implementation of two-frequency alternating synchronization sequence allows for synchronous parallel transmission of digital data in audio tones via telephone network.

### BACKGROUND TO THE INVENTION

A transtelephonic bio-monitor is a handheld battery operated device for acquisition, storage and transmission of recorded biological signals to the remote receiving station. Monitors use an audio frequency band of telephone line for transmission of stored data via a telephone network. Transtelephonic medical monitors are intended for a prolonged ambulatory use by the patients with cardiac problems. Patients can activate recording of their ECG and transmit the recording to the remote receiving station without the need for electrical connection of the device to the telephone line. This provides safe and simple operation of the monitor.

A typical transtelephonic monitor stores several portions, ie events of an acquired ECG signal in the memory in digital form. Stored ECG waveforms are transmitted via conventional telephone network using audio tones. Encoding of the ECG signal for transtelephonic transmission is very similar to a well-known frequency modulation (FM) encoding of an analogue signal.

The majority of commercial transtelephonic monitors use one-way transmission from the device to the station without feedback or handshaking because of complicated and unreliable hardware for reception of audio data back from the station. It is found to be impractical to use a large device, which matches the size of telephone handset with a microphone on one side and speaker on another because patients could not provide proper conditions for reliable audio modem operation. Such a device is also too bulky and inconvenient to use.

The commonly used band of 1650-2150 Hz is allocated for transmission of frequency encoded analogue ECG signal. Most of the transtelephonic monitors use 1900 Hz as a central frequency with ±2.5 mV dynamic range of ECG signal at 100 Hz/mV frequency deviation for analogue signal transmission. In fact, available frequency bandwidth is wider as a normal telephone line offers 600-3600 Hz bandwidth.

The use of a narrow frequency band and the absence of feedback in transtelephonic monitors make it impossible to transmit ECG data serially in digital form within reasonable time, therefore acquired analogue signals are transmitted in analogue form using frequency modulation technique.

ECG data is initially stored in the memory in digital form, this digital data is used for direct generation of the audio signal without converting the digital data back into an analogue voltage and then converting the restored analogue voltage into an analogue frequency by some sort of hardware voltage-to-frequency converter.

For data encoding monitors, a sequence of frequencies is generated specific for each of the ECG value. That is, if data is of 8 bit resolution, the monitor generates 256 different frequencies within the 1650-2150 Hz band for each possible value of analogue ECG signal.

The value of output audio frequency is updated at every sampling period. Some monitors use double or even triple transmission rate (accelerated transmission), when frequency is updated every half or third of the actual sampling period time.

It is therefore understandable that during transtelephonic transmission only single frequency is used at a time.

The use of the 500 Hz wide frequency band (1650-2150 Hz) limits the accuracy of an analogue (frequency modulated) transtelephonic transmission.

In order to provide acoustic transmission of analogue signal with 8 bit accuracy in the 1650-2150 Hz band, frequency resolution of 1.960 Hz/unit (50 OHZ/255) should be maintained by both the frequency encoder in the transmitter and the frequency decoder in the receiver or better than 0.09% at 2150 Hz. In other words, for values 254 and 255 difference in frequencies is 0.06%.

A frequency resolution of 0.488 Hz/unit is required in order to obtain 10 bit accuracy and for values 1023 and 1024 difference in frequencies is only 0.0001%.

It is a complicated task to maintain even 8 bit accuracy through the acoustic transtelephonic transmission due to the above considerations.

In practice, throughout accuracy of commercial transtelephonic systems achieved is 7 bit or 3.90 Hz/unit (0.18% accuracy at 2150 Hz).

Currently, few techniques are used in commercial receiving stations for frequency modulated data decoding.

The simplest method uses analogue frequency-to-voltage conversion to drive low resolution chart recorders.

Another method restores the original analogue signal and then digitizes it for further analysis by the computer. This technique requires at least two conversions of the signal: frequency-to-voltage and analogue-to-digital. It is understood that each conversion introduces additional phase, frequency and amplitude distortions to the signal. This technique requires special attachments to the computer: usually expensive custom designed set of filters or phase-locked loop devices, controllers and analogue-to-digital converters. It also requires upgrading of off-shelf computer by qualified personnel.

Another recently developed method uses recording of the sound received by the computer either via a sound card or voice modem. The sound is recorded into computer's memory in digital form with very high quality and with minimal distortions. Each modem computer is equipped with such a card. Software of the receiving station analyses recorded waves in order to retrieve the original signal. This software utilizes either digital filtering or spectral analysis. These methods also introduce phase, frequency and amplitude distortion to the recovered analogue signal. Digital filtering and spectral analysis are well known within the art.

In the methods of electrocardiogram encoding and decoding described above the following conversions of the original ECG signal take place:
(i) analogue-to-digital conversion of the original ECG signal; and
(ii) sequential digit-to-frequency conversion of the digitized ECG signal; and
(iii) frequency-to-analogue conversion and analogue-to-digital conversion; or
(iv) software frequency-to-digit conversion.

The initial analogue-to-digital conversion (i) digitizes the analogue signal with specified resolution and sampling rate.

The frequency encoding of digitized signal (ii) introduces non-linearity in amplitude and phase of the original signal.

The frequency-to-analogue and analogue-to-digital conversions (iii) are not synchronized to the initial analogue-to-digital conversion and therefore introduce further distortions to the original signal.

Software frequency-to-digital conversion (iv) has the uncertainty with the positioning of the window in spectral analysis or significant phase and frequency distortions in digital filtering due to unintentional averaging of the initial ECG samples. The problem arise with use of accelerated transmission.

All these drawbacks limit the use a method of frequency encoding of analogue signal in transtelephonic transmission only to a basic analysis of cardiac rhythm disorders.

Overall accuracy of this method due to uncertainty in timing, amplitude and phase of the actual initial sample of ECG signal does not meet requirements of American National Standard for diagnostic electrocardiographic devices EC 11-1982.

It would be advantageous to provide a method of transmission of digitized biological signal in digital form in transtelephonic medical monitors in order to attain a diagnostic quality biological data.

### OBJECT OF THE INVENTION

It is an object of present invention to provide a method and apparatus for transmission of digitized biological signals in digital form in transtelephonic bio-monitors which substantially overcomes or ameliorates the above mentioned disadvantages.

### DISCLOSURE OF THE INVENTION

According to one aspect of the present invention there is disclosed a method of synchronous parallel transmission of digital signals over a telephone line, said method including the steps of generating a synchronization signal having at least two frequencies, simultaneously generating data signals having at least two separate frequencies from the digital signals, converting said synchronization signal and said data signals into audio signals having frequencies corresponding to frequencies of said synchronization signal and said data signals to be transmitted over the telephone line and transmitting at least three frequencies of the audio signals simultaneously over the telephone line.

Preferably, the highest frequency of the transmitted signals is less than the frequency of the second harmonic of the data signals.

In a preferred form, the synchronization signal is presented as a high or low signal during transmission thereof to specify new data transmission. The period of alteration of the synchronization signal is determined by the receiver's response time. In other preferred forms, more than two logic levels are implemented depending on the total frequency band of the synchronization signal.

Preferably, the data signals are 10 bit words of binary code and are split into two 5 bit words for simultaneous transmission. Naturally, the number of bits in the transmitted words can be split into any number.

Using the preferred embodiment where the normal useful band of conventional telephone line is 600-3600 Hz, the output frequencies are generated as square TTL or CMOS pulses with a 50% duty cycle.

### BRIEF DESCRIPTION OF THE DRAWINGS

The present invention will be now be described with reference to the accompanying drawing in which:

FIG. 1 is a block diagram of the configuration of a transtelephonic monitor according to the preferred embodiment of the invention;

FIG. 2 shows a synchronization sequence of the transtelephonic monitor of FIG. 1;

FIG. 3 shows encoding for transtelephonic transmission of the transtelephonic monitor of FIG. 1;

FIG. 4 shows transmission of several 10 bit samples using the transtelephonic monitor of FIG. 1;

FIG. 5 shows distribution of audio frequencies in transtelephonic transmission using the transtelephonic monitor of FIG. 1; and

FIG. 6 shows a mixer for use of the transtelephonic monitor of FIG. 1.

### BEST MODE OF CARRYING OUT THE INVENTION

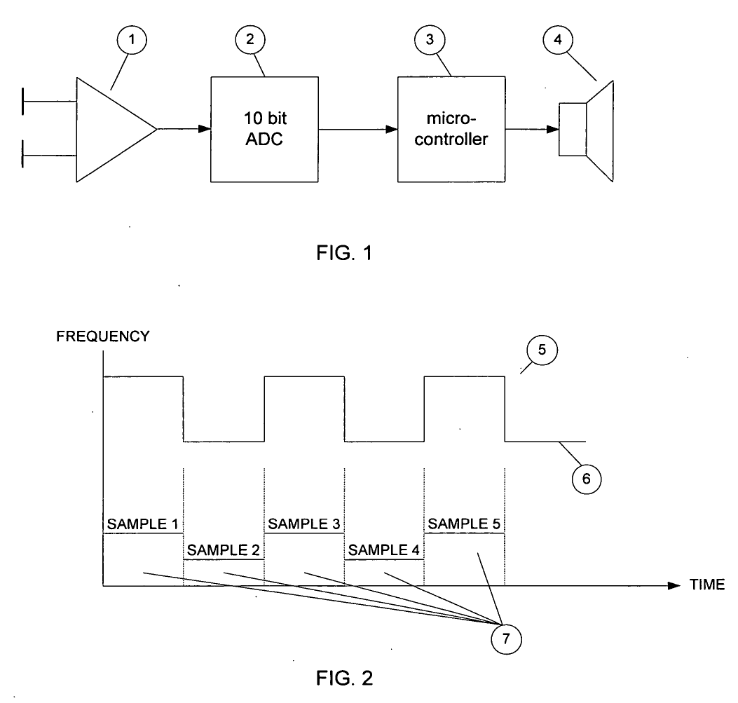

In a preferred embodiment of the present invention, a method for synchronous digital transmission of ECG signal via a acoustic telephone line is described. An ECG signal is preferably acquired at 500 HZ sample frequency and 10 bit resolution and stored in the memory of transtelephonic bio-monitor which is a single channel transtelephonic ECG monitor which is built on a single chip microcontroller as seen in FIG. 1. The monitor is preferably an off the shelf computer with sound card used as a transtelephonic receiving station.

Of course, signals other than ECG signals and/or digitized under different settings of analogue-to-digital conversion signals can also be transmitted using this method.

Referring to FIG. 1, an ECG amplifier 1 amplifies the ECG signal. The output of the ECG amplifier 1 is connected to an input of an analogue-to-digital converter (ADC) 2. The analogue-to-digital converter 2 is controlled by a microcontroller 3. The microcontroller 3 receives from the ADC 2 a 10 bit value of digitized ECG signal. The microcontroller 3 generates output audio frequencies for a speaker 4.

The most important condition in data transmission is synchronization of the transmitter and receiver or synchronization of the start and end of the transmitted word so that the receiver can reliably recognize boundaries of the received data. In serial asynchronous transmission special start and stop bits determine beginning and end of a received byte.

Synchronization of the transmitter and receiver is used in parallel and serial synchronous data transfer. A special synchronization signal is generated in order to tell to the receiver that new data on its input is available.

In conventional microprocessor systems the synchronization signal is presented as high or low level on a dedicated synchronization line. This line holds a “valid data” state sufficiently for the receiver's processing time.

There is then a certain period of a “data not valid” state before new data can be read. These periods of “data not valid” waiting states are essential because they provide the initial condition for the “data valid” state, eg transition of synchronization signal from high to low level.

In transtelephonic transmission, the number of available signal levels is limited only by available frequency band and acceptable frequency separation between levels. For example, if the total frequency band is 2000 Hz, and logic levels are separated by 10 Hz for better noise immunity, up to 200 logic levels can be implemented.

The synchronization signal in the preferred embodiment of the present is presented by two frequencies each indicating “new data” state. These frequencies are altered with a specified period during transmission allowing for data transmission without the necessity of a waiting state. The period of alteration of synchronization signal is determined by the receiver's response time. The faster the receiver can detect a new synchronization frequency, the shorter period of synchronization can be set. There is a certain delay in detection of new synchronization frequency and it is related to the nature of digital filtering and spectral analysis. Due to the necessity to acquire a certain number of periods of analyzed signal, the higher frequencies of synchronization logical levels will require shorter detection time, therefore it is preferable to use the highest frequencies for synchronization purposes.

Implementation of synchronization resolves two major issues:

Improved reliability of detection of dominant frequency of the transmitted ECG sample due to the accurate positioning of window in spectral analysis and;

Shortest synchronization period defines fastest transmission rate. The transmission rate will not affect quality of transmission regardless of the actual signal acquisition sampling rate. Of course, the actual sampling rate of the monitor should be known to the receiving station.

FIG. 2 shows a synchronization sequence in the preferred embodiment of present invention. Two synchronization frequencies 5 and 6 are altered every synchronization period 7. Each alteration corresponds to a transmission of new ECG data sample and enables the receiver to start reception of this new sample.

As mentioned above, 10 bit resolution of analogue-to-digital conversion makes 1024 different digital values in a digitized signal. In analogue transmission using FM encoding it would require at least 1024 frequencies to be generated with very high precision. On the other hand, all 1024 values are packed in only 10 bits of binary code. This 10 bit binary word can be split into two 5 bit words with only 32 values in each. Therefore only 64 different frequencies need to be generated for the transmission. Each 10 bit value will be represented by only two frequencies defined by two 5 bit words. Of course, these frequencies are separated sufficiently for the noise immunity.

Simultaneous generation of two frequencies corresponding to 5 bit words concurrently with the “new data” synchronization signal will compose one synchronous parallel 10 bit word.

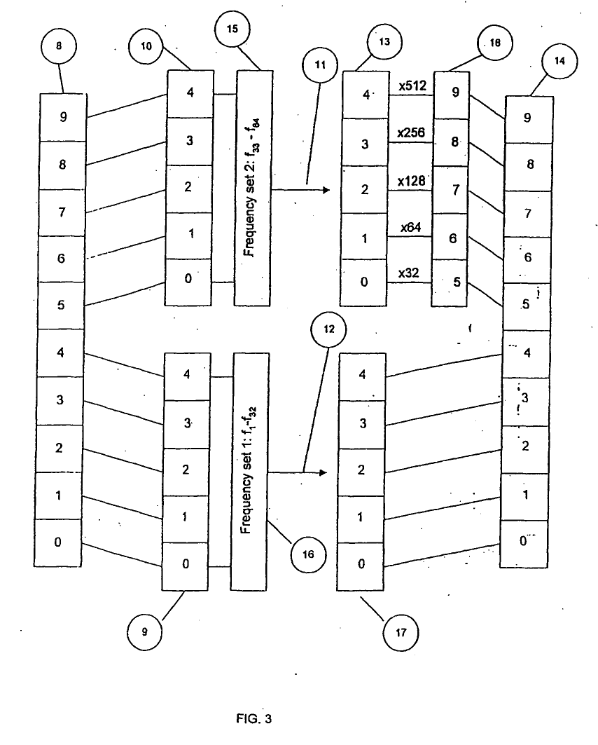

FIG. 3 shows encoding for transtelephonic transmission of 10 bit ECG value 8 and decoding of received data into 10 bit value 14. The value or word 8 is split into two 5 bit words 9 and 10. Word 9 carries 5 least significant bits of the 10 bit word 8 while word 10 carries 5 most significant bits of the 10 bit word 8. Two frequency sets 15 and 16 are formulated and associated with 5 bit words. Each frequency set is composed of 32 specific frequencies each corresponding to one of 32 values of the 5 bit word. The frequency set 16 (frequencies f1-f32) is associated to the least significant word 9 and the frequency set 15 (frequencies f33-f64) is associated to the most significant word 10. Two frequencies 11 and 12 are then selected from frequency sets 15 and 16 respectively. The frequency 11 represents one of the 32 values of the 5 bit word 10 and the frequency 12 represents one of the 32 values of the 5 bit word 9.

Upon reception and measurement by the receiver each frequency will be decoded into a corresponding 5 bit word. The frequency 12 forms word 17 and frequency 11 forms word 13. The least significant word 17 remains unchanged. The most significant word 13 is first restored to its binary form and then each bit is multiplied by its weighting factor. This procedure forms a new 5 bit word 18. The two words 17 and 18 are added together and forms a 10 bit value equal to the original value of the transmitted sample 8.

Of course, the total number of bits in the transmitted word can be different and the word can be split into any number of simpler words. For example, a two-channel ECG monitor transmits two 10 bit words simultaneously using four frequency sets or a 16 bit word can be split into four frequency sets with 16 frequencies per set. Of course, the number of frequency sets can be equal to the number of bits in the original word. In this case each frequency set will include only two frequencies.

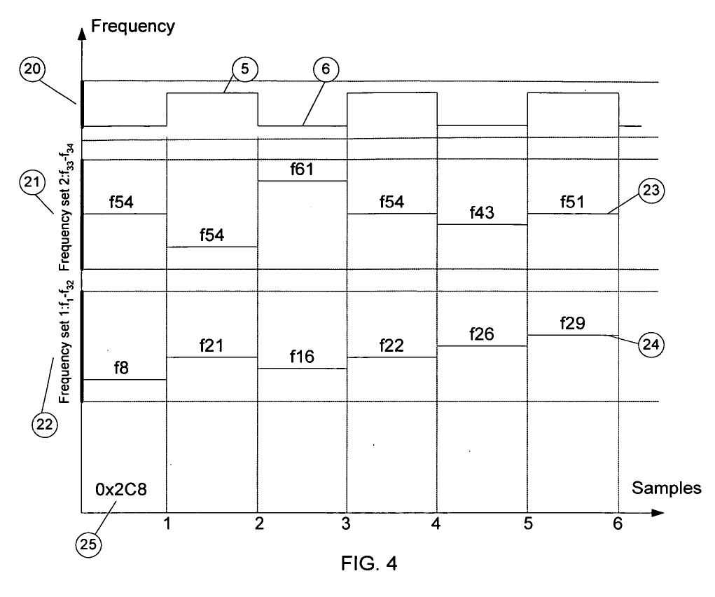

FIG. 4 shows transmission of several 10 bit samples. Three transmission channels 20, 21 and 22 allocate frequency bands for synchronization (20), frequency set 2 (21) and frequency set 1 (22). According to the preferred embodiment, only two frequencies 5 and 6 are used for synchronization in channel 20. Channels 21 and 22 contain 32 frequencies each. Three frequencies are transmitted concurrently. Each of two synchronization frequencies 5 and 6 indicate a new data sample. Frequencies 23 and 24 represent the most significant and the least significant halves of the transmitting 10 bit word. A sample value 25 corresponds to the shown example of f8 and f54 for the first transmitted sample.

Using the preferred embodiment where the normal useful band of conventional telephone line is 600-3600 Hz, the output frequencies are generated as square TTL or CMOS pulses with a 50% duty cycle. The transmitted square pulses cause generation of second and third harmonics, that is for a 1800 Hz signal, a second of 3600 Hz and third of 5400 Hz harmonics will be generated. These harmonics, being superimposed onto the transmitted signal will cause interference and potential data loss.

Simultaneous transmission of several frequencies without interference with the higher harmonics is possible if the highest transmitted frequency is lower than frequency of the second harmonic of the lowest transmitted frequency.

FIG. 5 shows distribution of audio frequencies in transtelephonic transmission. The entire frequency band of the telephone line is indicated by line 30. Maximal frequency band 31 is achieved when the lowest transmitting frequency is set to the half of the maximal transmitting frequency of the telephone line frequency band. In this example the usable band is 1800-3590 Hz.

Referring again to FIG. 5, the frequency allocation for the frequency set 1 is shown as the channel 32, frequency set 2 is shown as the channel 33 and synchronization channel 34 is shown. The lowest part of frequency band 35 generated by second harmonics is shown in respect to the highest used frequency. In this example all used frequencies generate harmonics with frequencies higher than highest transmitted frequency.

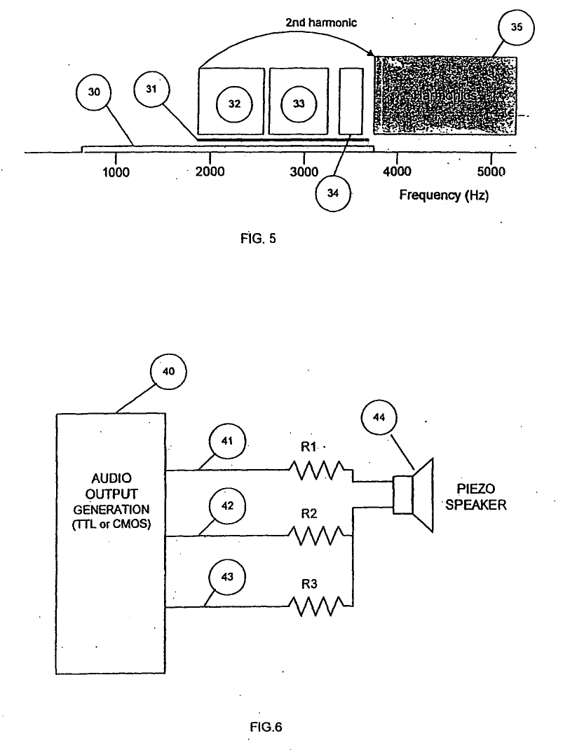

The technique of generating of several frequencies is well known within the art. In the preferred embodiment three frequencies are generated simultaneously on three independent outputs. Output signals are mixed together and applied to the speaker 44 as shown in FIG. 6 where a simple mixer of three independently generated TTL or CMOS signals is shown. A microcontroller 40 generates a synchronization signal 41 which is connected via current a limiting resistor R1 to one side of the speaker 44.

A microcontroller 40 also generates signals 42 and 43. Signal 42 is assigned to frequency set 1 (f1-f32). Signal 43 is assigned to frequency set 2 (f33-f64). Signals 42 and 43 are connected to the other side of the speaker 44.

Referring again to FIG. 6, the speaker 44 is preferably a piezo speaker with typical impedance of 2,000 Ohm and oscillating frequency of 250-4,000 Hz. In the preferred embodiment a KPE-007 piezo speaker from Kingstate Electronics corporation is used. Values of R1, R2 and R3 are equal. In the shown configuration, the speaker 44 is driven in a pseudo push-pull mode by TTL or CMOS output signals. Of course, a wide variety of analogue mixers can be used in this application.

The foregoing describes only some embodiments of the present invention, and modifications obvious to those skilled in the art can be made thereto without departing from the scope of the present invention.

1. A method of synchronous parallel transmission of digital signals over a telephone line, said method including the steps of generating a synchronization signal having at least two frequencies, simultaneously generating data signals having at least two separate frequencies from the digital signals, converting said synchronization signal and said data signals into audio signals having frequencies corresponding to frequencies of said synchronization signal and said data signals to be transmitted over the telephone line and transmitting at least three frequencies of the audio signals simultaneously over the telephone line.

2. The method according to claim 1, wherein the highest frequency of the transmitted signals is less than the frequency of the second harmonic of the data signals.

3. The method according to claim 1, wherein the synchronization signal is presented as a high or low signal during transmission thereof to specify new data transmission.

4. The method according to claim 1, wherein period of alteration of the synchronization signal is determined by the receiver's response time.

5. The method according to claim 1, wherein more than two logic levels are implemented depending on the total frequency band of the synchronization signal.

6. The method according to claim 1, wherein the data signals are multiple bit words of binary code and are split into a number of multiple bit words for multiple transmission.

7. The method according to claim 6, wherein the data signals are 10 bit words of binary code and are split into two 5 bit words for simultaneous transmission.

8. The method according to claim 1, wherein normal useful band of conventional telephone line is 600-3600 Hz, the output frequencies are generated as squar TTL or CMOS pulses with a 50% duty cycle.
